(19) United States
(12) Patent Application Publication
(10) Pub. No.: US 2020/0186623 A1
(43) Pub. Date: Jun. 11, 2020

(54) PERFORMANT RETRIEVAL AND PRESENTATION OF CONTENT

(71) Applicant: MICROSOFT TECHNOLOGY LICENSING, LLC, Redmond, WA (US)

(72) Inventors: Diego Felipe MARTINEZ DIAZ, Bellevue, WA (US); James Buel PALMER, Redmond, WA (US); Amit GUSAIN, Bothell, WA (US); Venkat Pradeep CHILAKAMARRI, Seattle, WA (US); Om KRISHNA, Redmond, WA (US)

(21) Appl. No.: 16/353,798

(22) Filed: Mar. 14, 2019

Related U.S. Application Data
(60) Provisional application No. 62/778,071, filed on Dec. 11, 2018.

(51) Int. Cl. H04L 29/06; H04L 29/08

(52) U.S. Cl. CPC H04L 67/42; G06F 3/0484; H04L 67/06

(57) ABSTRACT

Technologies are provided for performant retrieval and presentation of content in a user interface. In some embodiments, an application is configured with executable code for presenting content in predefined areas of a UI. The executable code defines a layout of the areas and provides formatting information, but does not include the content. At runtime, such as during an initial period prior to when the application is ready to process user input, a thread that is separate from a main application thread requests content from a remote server. The content can include text, for example. Regardless of its type, the content excludes formatting information. The application causes a display device to present received content in the predefined areas of the UI. To that end, the application utilizes the same program code that the application utilizes to display other content pertaining to the application.

### CROSS-REFERENCE TO RELATED APPLICATION

This application claims the benefit of and priority to U.S. Provisional Patent Application No. 62/778,071, filed Dec. 11, 2018, the contents of which application are hereby incorporated by reference herein in their entireties.

### BACKGROUND

Content presented by software applications is typically updated in two ways. Some applications, for example, are hard-coded to present predefined content. Applications configured in this way can present content in a highly performant manner because the content is predefined by the application and is not retrieved from a remote network service. This can be particularly beneficial when high performance is critical, such as when it is desirable to present content to a user as soon as possible after an application has been launched.

In order to update the content presented by applications configured with hard-coded content, it is typically necessary to issue updates to the application that include new content. Updating an application, however, can require significant network bandwidth and other processing resources and, as a result, software updates are typically not issued frequently. Consequently, the content presented by such applications can become stale between updates.

Applications can also be configured to retrieve content at runtime. For instance, an application might retrieve content from a remote network service at runtime for presentation. In these configurations, the presented content can be easily and quickly updated by storing new content at the network service. A software update to such an application is not required in order to update displayed content as in the configurations described above.

Retrieving content from a network service at runtime can, however, negatively impact the performance of an application and the computing system executing the application. For instance, retrieving such content might take a long time because such content is typically formatted according to web standards (e.g., standards defined by the World Wide Web Consortium (W3C)). As a result, a large amount of data can be required to define the content. Additionally, when such content is formatted according to web standards, it is typically necessary to utilize sizable and complex program code (e.g., a WebView) to render the content. Loading and execution of this type of program code can take a long time and utilize significant computing resources. As a result, execution of such program code during the initialization of an application can significantly extend the time required for an application to become ready for use by a user.

It is with respect to these and other technical challenges that the disclosure made herein is presented.

### SUMMARY

Technologies are disclosed herein for performant retrieval of content and presentation of the content in a UI. Through implementations of the disclosed technologies, content can be both dynamically updated without an update to an application that consumes the content and presented in a performant manner. This can improve the performance of an application executing on a computing system by, for example, reducing the amount of time required for an application to become ready for use by a user. Technical benefits other than those described herein might also be realized through implementations of the disclosed technologies.

As is described in greater detail below, the technologies disclosed herein utilize a software application that is configured with executable code for presenting content in predefined areas of a UI. The executable code defines a layout and format for the areas, but does not include the content itself. At runtime, such as during an initial period of execution following the launch of an application but prior the software being ready to process user input, an execution thread separate from the main application thread requests content from a remote server. Because the thread executes separate from the main application thread, requesting and receiving the content does not block the main application thread from initializing the software application.

The content can include text to be displayed, for example, but excludes formatting information. Therefore, the amount of data needed to represent the content is very small. The content might include only text or, in some instances, the content also can include data identifying a location of a media asset (e.g., an image or video) in a content repository.

In other instances, the content also can include data defining a portion (e.g., a function or routine) of the application. For instance, the content can identify a portion of the executable program code configured to display the content in a particular way (e.g. placement, font, colors, etc.). The content also can identify a particular element of a UI as being associated with the executable code. Regardless the type of content, by excluding formatting information from the content, retrieval of the content significantly reduces the amount of time required to retrieve the content from a network service and, therefore, enables this to occur during the time between when an application is launched and the time it is ready to receive user input with minimal delay.

The software application also can present the received content in the predefined areas of the UI. To that end, the application uses the same program code (e.g. APIs) to display the retrieved content that the software application utilizes to display other content pertaining to the application. Accordingly, in stark contrast to conventional technologies for displaying content that require loading and execution of sizable and complex program code (e.g., a WebView), there is no need to load additional libraries, APIs, or other program code to present the content. This also enables performant presentation of the content, particularly during the time between when an application is launched and the time it is ready to receive user input with minimal delay. These aspects can also reduce the utilization of processor cycles, memory, energy, mass storage, and network bandwidth by retrieving minimally-sized content and avoiding the loading and execution of additional program code for presenting the content.

It is noted that the above-described subject matter can be implemented as a computer-controlled apparatus, a computer-implemented method, a computing device, or as an article of manufacture, such as a computer-readable storage medium. These and various other features will be apparent from a reading of the following Detailed Description and a review of the associated drawings.

This Summary is provided to introduce a brief description of some aspects of the disclosed technologies in a simplified form that are further described below in the Detailed Description. This Summary is not intended to identify key features or essential features of the claimed subject matter, nor is it intended that this Summary be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a computing architecture diagram that illustrates aspects of an example of a system for performant retrieval and presentation of content in a UI, in accordance with one or more embodiments of this disclosure;

FIGS. 2A and 2B are user interface diagrams that illustrate respective UIs, in accordance with one or more embodiments of this disclosure.

FIG. 2C is a UI diagram that illustrates selectable visual elements that can be included in a UI, in accordance with one or more embodiments of this disclosure.

FIGS. 3A-3D are user interface diagrams that illustrate respective UIs, in accordance with one or more embodiments of this disclosure.

FIGS. 4 and 5 are flow diagrams illustrating respective methods for retrieving and presenting content in a UI, in accordance with one or more embodiments of this disclosure.

FIG. 6 is a computer architecture diagram illustrating computer hardware and software architectures for a computing device that can implement aspects of the technologies disclosed herein; and

FIG. 7 is a network diagram illustrating a distributed computing environment that can implement aspects of the technologies disclosed herein.

### DETAILED DESCRIPTION

The following detailed description is directed to technologies for performant retrieval of content and presentation of the content in a UI. As discussed briefly above, processor cycles, memory, energy, mass storage, and network bandwidth might be conserved through implementations of the disclosed technologies. Other technical benefits not specifically mentioned herein can also be realized through implementations of the disclosed subject matter.

While the subject matter described herein is presented in the general context of a desktop or server computer, those skilled in the art will recognize that other implementations can be performed in combination with other types of computing systems and modules. Those skilled in the art will also appreciate that the subject matter described herein can be practiced with other computer system configurations, including hand-held devices, multiprocessor systems, microprocessor-based or programmable consumer electronics, computing or processing systems embedded in devices (such as wearable computing devices, automobiles, home automation, etc.), minicomputers, mainframe computers, and the like.

In the following detailed description, references are made to the accompanying drawings that form a part hereof, and which are shown by way of illustration specific configurations or examples. Referring now to the drawings, in which like numerals represent like elements throughout the several FIGS., technologies for performant retrieval of content and presentation of the content delivery of content to a UI, using a network service, will be described.

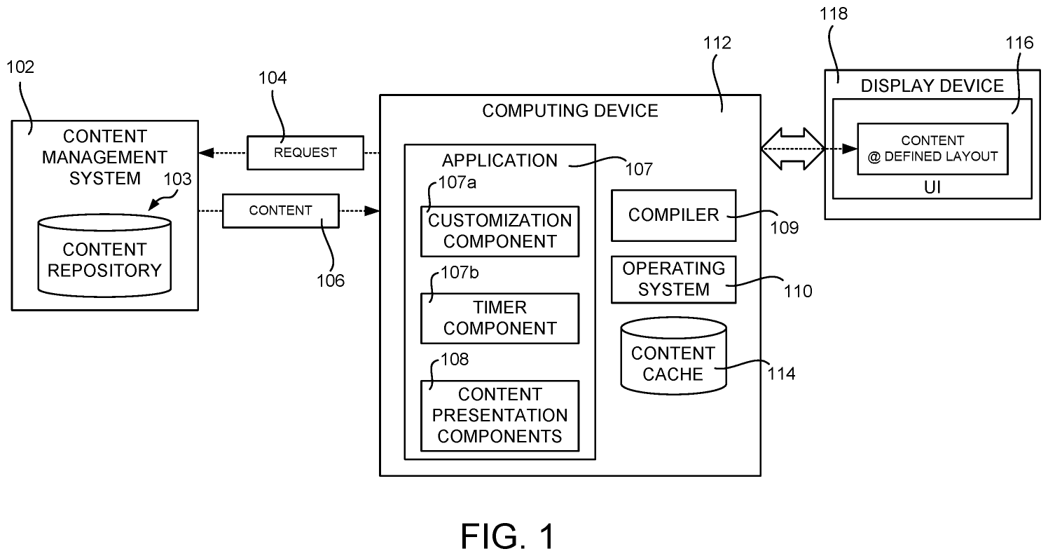

FIG. 1 is a computing architecture diagram that shows aspects of an illustrative system for performant retrieval and presentation of content in a UI. As shown in FIG. 1, a computing device 112 can include an application 107. During execution the application 107 can cause a display device 118 to present multiple UIs that can facilitate various types of functionality provided by the application 107. The UIs can include, for example, a landing page, a dialog box, a web-based help interface, and the like.

As described in greater detail below, each one of the multiple UIs can present content in a specific layout with specific formatting. The specific layout can define a spatial arrangement of content within a UI. For instance, the specific layout can define positioning of the content (center-aligned content, left-aligned content, etc.) and amount of screen area available for placement of specific portions of the content. Such a layout is static in that the layout is defined at build time of the application 107.

To draw the UIs, the application 107 can be configured to utilize program code (e.g., libraries, APIs, and the like) exposed by an O/S 110 of the computing device 112. Accordingly, the application 107 can draw a UI 116 in such a fashion using the program code (e.g., APIs) directly at runtime.

The application 107 also can include content presentation components 108 for presenting content at predefined areas on the UI 116. Each one of the content presentation components 108 is embodied in executable code (e.g. executable modules, APIs, or functions) and can be configured to display content using a different layout and format. A defined content presentation component of the content presentation components 108 can present content in the UI 116 using one or many of the same libraries, APIs, or program code used by the application 107 to draw the UI 116.

More specifically, each one of the content presentation components 108 defines a layout of the predefined areas on a UI in a markup language, where each one of the areas is configured to present respective content. Each one of the content presentation components 108 also can define themes or types of the content to be presented in each of such areas. In addition, each one of the content presentation components 108 also defines formatting (e.g., shape, size, font, font type, color, and the like) for each one of the areas.

Each one of the content presentation components 108 also can configure at least one of such areas as a selectable visual element that is actionable. Specifically, a first content presentation component of the content presentation components 108 can configure a first area of the predefined areas as a first selectable visual element. In response to selection of the first selectable visual element, an action can be performed by the computing device 112, e.g., presenting a dialog window; presenting a browser with a specific uniform resource locator (URL); presenting a sign-in prompt; or the like. Such an action permits interaction directly with the application 107. The action, however, is not defined by the first content presentation component. Instead, the content defines the action.

Each one of the content presentation components 108 is human-readable text file (e.g., an XML file or an HTML file) and is not rendered by a browser application. Instead, each one of the content presentation components 108 includes program code that is generated at compile time. As such, the computing device 112 can include a compiler 109 that can compile each one of the content presentation components 108 at the time of building the application 107. In some instances, the executable code that forms a content presentation component and the application 107 can be compiled on one computing device and distributed to another computing device for execution. In some embodiments, the application 107 can include a single UI presentation component instead of the multiple content presentation components 108.

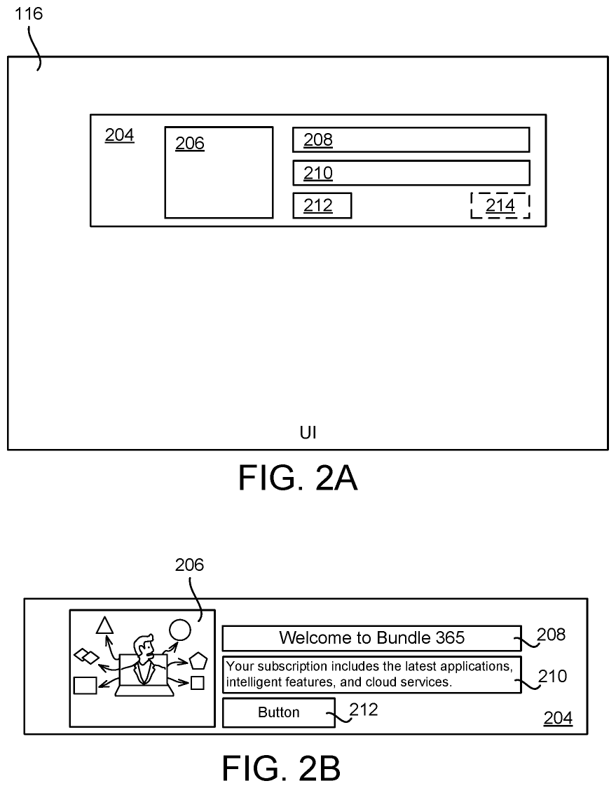

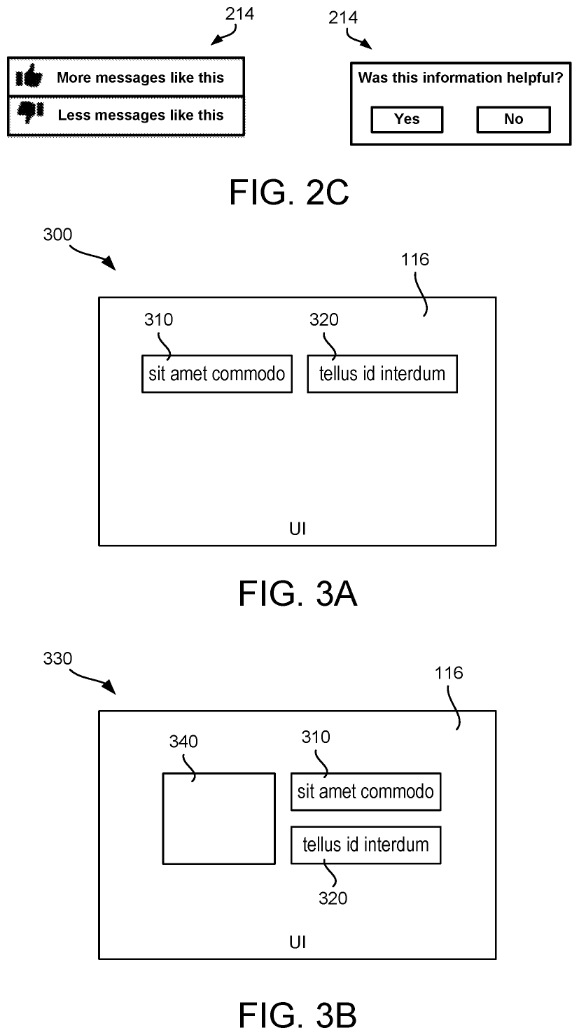

The areas defined and arranged by a particular content presentation component can span a section of the UI or the entire screen area available to the UI. As an illustration, FIG. 2A presents an example of the configuration of a UI 116 that can be presented by a first content presentation component of the content presentation components 108. The first content presentation component defines, for example, a layout of four areas within a section 204 of the UI 116. Each one of the four areas can present different content. A first area 206 can present an image; a second area 208 can present a title; a third area 210 can present a message; and a fourth area 212 can present a selectable visual element (such as a UI button). As an illustration, FIG. 2B presents an example of the four areas 206, 208, 210, and 212 within the section 204 of the UI 116. The first content presentation component also can define the format of the title and the message, e.g., font, font size, underlining, color, a combination thereof, or the like.

The first content presentation component also can configure a selectable visual element to include a string or another type of text. Again, the first content presentation component can define the format of such a string or text. In some examples, in accordance with aspects disclosed herein, the first content presentation component can configure the selectable visual element as an actionable element. As such, a specific action defined by the content can be performed by the computing device 112 in response to selection of the selectable visual element. Information (data and/or metadata) identifying the specific action can be stored within the content 106.

Such information can include data indicative of specific executable code of the application 107, where the code is configured to perform the specific action. The specific executable code can determine, at least partially, a result of implementing the action. The computing device 112 can execute the specific executable code in response to selection of the selectable visual element. Executing the specific executable code can result in executing a specific function call associated with the application 107, for example. As such, execution of the specific executable code corresponds to direct interaction with the application 107. The specific executable code can be, for example, one of an O/S API, executable code in the application 107, or the like. As a result of executing the code, the computing device 112 can perform the specific action.

As an example, the specific action can be one of presenting a modal web dialog window; presenting a browser with a specific given URL; presenting a sign-in prompt; presenting a prompt for feedback related to the content in the section 204; or the like. For instance, parameters of the specific action can define a size of the dialog window. In response to implementation the specific action, the dialog box can be presented according to such a size.

A specific activity can be completed after the specific action is performed. Such an activity and action can be related to the text presented in the third area 212, for example. The specific action can characterize the functionality of the first content presentation component.

By configuring the selectable visual element to perform an action—without specifying what the action is—a particular content presentation component of the content presentation components 108 can control the implementation of functionality corresponding to the application 107. Yet, neither the application 107 nor such a particular content presentation component need to be recompiled to implement different actions because the content management system 102 defines the specific action(s) associated with actionable elements defined by the particular content presentation component. Therefore, in contrast to conventional UI technologies, the technologies disclosed herein provide superior agility in the programming of new customized functionality in an already compiled application.

For each of the four areas shown in FIG. 2A, the first content presentation component can specify constraints. For example, the first content presentation component can define a width and a height for the first area 206. The width corresponds to a defined length along the major side of the section 204, and the height corresponds to another defined length along the minor side of the section 204.

The first content presentation component also can define three types, e.g., light, dark, and high-contrast, for an image that is presented in the first area 206. A high-contrast image can be a black-on-transparent image (e.g., a portable network graphics (PNG) image), which can permit recoloring the image at runtime according to a preference of an end-user.

The first content presentation component also can define a width and height of the second area 208, and a maximum number of characters and a maximum number of words per line of text presented in the second area 208. In one example, the maximum number of characters can be 75 and the maximum number of words can range from eight to 12. The first content presentation component can further define a width and height of the third area 212.

In some embodiments, a group of one or many of the content presentation components 108 can provide similar functionality across the group, such as dismiss behavior and/or collapse behavior. Either behavior causing the presentation of a defined section (e.g., section 204, FIG. 2A, FIG. 2B) of the UI 116 to cease, and the UI 116 to be redrawn without the defined section. In addition, or in other embodiments, at least one of the content presentation components 108 can provide feedback functionality. For instance, the first content presentation component of the content presentation components 108 that defines the layout of areas on the section 204 can, in some cases, define one or more selectable visual elements 214. The selectable visual element(s) 214 can permit the computing device 112 to receive feedback information related to the content presented in the section 204 of the UI 116. Feedback information can permit understanding more explicitly if an end-user finds the content useful. As an illustration, FIG. 2C presents examples of selectable visual elements(s) 214.

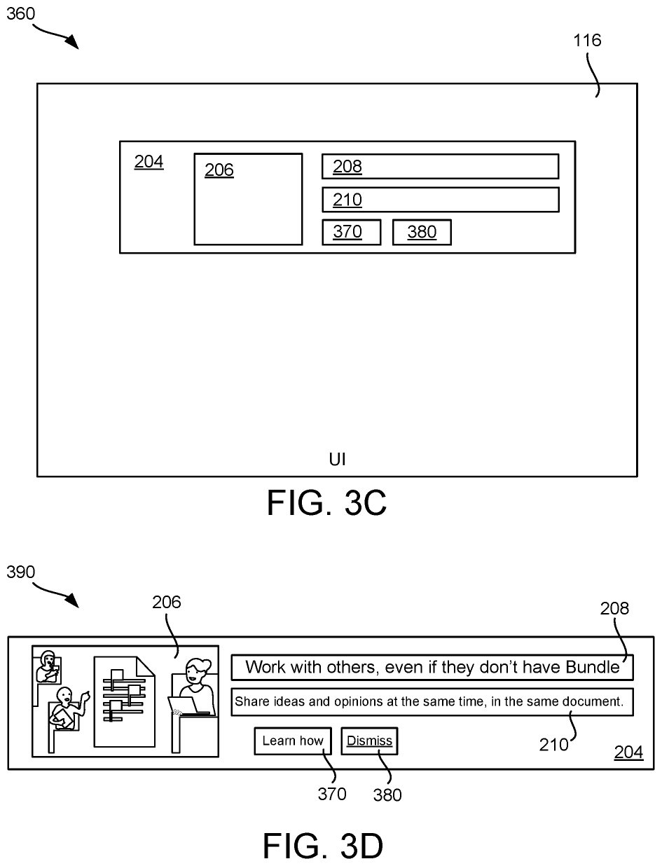

One or many of the content presentation components 108 need not include a selectable visual element, whereas a second content presentation component of the content presentation components 108 can include more than one selectable visual element. As is illustrated in FIG. 3A, a diagram 300 presents an example of the UI 116 in which a first selectable visual element 310 and a second selectable visual element 320 are presented adjacent to each other in the UI 116. As another example, FIG. 3B presents a diagram 330 where an image 340 is presented adjacent to the first selectable visual element 310 and the second visual element 320. The selectable visual elements 310 and 320 include respective text (represented with lorem ipsum fragments).

Respective specific actions can be performed in response to selecting the visual elements 310 and 320. In accordance with aspects discussed herein, the second content presentation component configures the selectable visual elements 310 and 320 as being actionable elements associated with the respective actions. The content management system 102 defines the respective actions. The content management system 102 also defines the text, without any formatting information, to be presented in each one of the selectable visual elements 310 and 320. The second content presentation component can define the format (e.g., color, shape and size, font, font size, and text color) and arrangement of each one of the selectable visual elements 310 and 320.

Further, as is illustrated in the diagram 360 in FIG. 3C, the second content presentation component can define a layout similar to the one defined by the first content presentation component discussed above in connection with FIG. 2A-2B. The second content presentation component of the content presentation components 108, however, defines a first selectable element 370 and a second visual element 380. Such elements are presented adjacent to each other in the UI 116. The selectable visual elements 370 and 380 include respective text. Respective specific actions can be performed in response to selecting the visual elements 310 and 320. Again, the second content presentation component configures the selectable visual elements 370 and 380 as being associated with the respective actions, and the content management system 102 defines the respective actions themselves. The content management system 102 also defines the text, without any formatting information, to be presented in each one of the selectable visual elements 310 and 320. The second content presentation component defines the format (e.g., color, shape and size, font, font size, and text color) and arrangement of each one of the selectable visual elements 370 and 380.

Specifically, as is shown in the example diagram 390 in FIG. 3D, the first selectable visual element 370 presents text that conveys an action related to the message 210. For example, the action can include educating an end-user on how to share documents with other in order to collaborate. Thus, selection of the selectable visual element 370 can cause the computing device 112 to open a web browser that presents appropriate educational materials. For instance, the web browser can launch a tutorial UI that guides an end-user through a defined process step by step. In other cases, the web browser can present source code of a particular UI executable code in human-readable form. As mentioned, neither the text nor the action is defined by second content presentation component of the content presentation components 108, instead it is the content management system 102 that defines the text and action.

The second selectable visual element 380 can present text that conveys that the section 204 ceases to be presented in response to selection of the visual element 380. Removing the section 204 can include, in some embodiments, executing an animation of other content present in the UI 116.

With further reference to FIG. 1, in response to initiating execution of the application 107, the computing device 112 can send a request 104 for content from a content management system 102. To that end, the computing device 112 can execute a customization component 107a in a worker thread, for example. The customization component 107a can be embodied in, or can include, for example, a group of APIs. The worker thread is implemented essentially concurrently with a main thread that executes the application 107.

As part of execution of the customization component 107a, the worker thread can execute a network call that sends the request 104 over a network (a wireless network, a wireline network, or a combination of both; not depicted in FIG. 1). Accordingly, the network call need not be executed in the main thread, which permits continuing starting the application 107 while the content is requested and, in some instances, received from the content management system 102.

In addition, essentially concurrently with the execution of the customization module 107a, the computing device 112 also can execute a timer module 107b in a second worker thread that enforces timeout logic for reception of a response to the request 104. Execution of the timer module 107b permits avoiding drawing portions of the UI 116 prior that do not rely on the requested content prior to the request 104 being resolved.

The content, as mentioned, can include media assets, such as strings, images, animations, video segments, audio segments, and so forth. The content also can identify a particular content presentation component of the components 108 to use to draw the UI 116. Yet, as also mentioned, the content does not include any kind of formatting information. At least some of the media assets have respective multimedia formats. The content can be informative, including notifications or other types of messages that can convey actionable information related to the application 107, for example

In some embodiments, the content can include directed content that can be targeted to a specific end-user and/or a specific application. Thus, the directed content can include, for example, advertisements, user-specific content, and/or application-specific content. In some instances, some content that is available to the content management system 102 can be provided by a user, without a requirement for the user to know how to code or otherwise design a template.

The content management system 102 has information that permits fulfilling the request 104. In one example, the content management system 102 and the computing device 112 can have a shared contract that specifies content payload (e.g., media assets) required by each one of the content presentation components 108 included in the application 107. The shared contract can be, in some embodiments, a flat JavaScript object notation (JSON) serialized key-value map that follows an example a Bond schema, such as:

struct ContentPayload
{

string title;
string body;
string imageLight;
string imageDark;
string imageHighContrast;
string imageAlternateText;
string buttonText;
string buttonAction;

}

In one example, the shared contract as defined by ContentPayload can be the following:

{

| “heading”: “Sign in to use your Office 365 benefits”, | |
|---|---|
| “body”: “With your subscription, ... and services.”, | |
| “buttonText”: “Sign In”, | |
| “buttonAction”: | “{\“call\”:\“showSignIn\”, |

\“args\”:[ ]}”,

“imageLight”: “/homepage/img.png”,
“imageDark”: “/homepage/img.png”,
“imageHighContrast”: “/homepage/img.png”,
“imageAlternateText”: “Woman sitting at computer

desk”
}

Other examples can include,

{

| “buttonText_1”: “sit amet commodo”, | |
|---|---|
| “buttonText_2”: “tellus id interdum”, | |
| “buttonAction”: | “{\“call\”:\“executable_code\”, |

\“args\”: [ ]}”,
}

and

{

| “imageLight”: “/homepage/img.png”, | |
|---|---|
| “buttonText_1”: “sit amet commodo”, | |
| “buttonText_2”: “tellus id interdum”, | |
| “buttonAction”: | “{\“call\”:\“showMsoSignIn\”, |

\“args\”:[ ]}”,

“imageLight”: “/homepage/img.png”,
“imageDark”: “/homepage/img.png”,
“imageHighContrast”: “/homepage/img.png”,
“imageAlternateText”: “Woman sitting at computer

desk”
}

The disclosure is not limited to a JSON format and/or a particular schema to define a shared contract. Content payload can be defined according to most any markup language.

The computing device 112 can ensure that it requests, from the content management system 102, all content required by a particular content presentation component. Accordingly, the request 104 can be embodied in a message that includes a desired group of fields consistent with one or more defined content presentation components. Some fields in a defined content presentation component can be mandatory and other fields can be optional.

In response to the request 104, a network service provided by the content management system 102 can identify a specific content presentation component using the request 104 and can supply content 106 to the computing device. The content 106 can include content payload consistent with the shared contract described above. The content payload can be embodied in a plain-text file including a flat JSON serialized key-value map.

In contrast to conventional technologies, instead of including formatting information and/or defining a layout for presentation of content in a UI, the content payload data included in the content 106 characterizes one or more fields present in a defined content presentation component built in the application 107. Therefore, the content 106 can be characterized with a small amount of data and/or metadata (e.g., hundreds of bytes, if not less). As is discussed herein, it is the defined content presentation component that defines formatting and a layout for presentation of media assets in a UI.

The content 106 also can include an image, an animation, or another type of media asset, retrieved from a content repository 103 in response to drawing the UI 116 according to the defined content presentation component. The content repository 103 includes one or several memory devices retaining various media assets. In one embodiment, the content repository 103 is embodied in a content distribution network (CDN).

Media assets in the content repository 103 can be segmented according to end-user groups targeted for a specific directed-content campaign. In addition, or in some embodiments, the media assets can include groups of assets specific to respective application. For instance, a first group of media assets is directed to a first application 107 and a second group of media assets is directed to a second application 107.

In some situations, the content 106 can be supplied to the computing device 112 and read and parsed at the computing device 112 before a timeout interval elapses. The timeout interval determines an upper bound for a satisfactory delay in acquiring the content 106. Thus, the timeout interval can ensure that degradation of the time performance of starting the application 107 does not exceed a defined threshold (e.g., about 3% slowdown relative to initiating the application 107 without service-delivered content).

The timeout interval also can ensure that the UI 116 is drawn within the user-perceptible readiness period of the application 107—e.g., the intervening time between launching the application 107 and having the application 107 available to process user input. The timeout interval is configurable and can be based on numerous factors, including historical loading performance, e.g., network delays, number of times that the content 106 is received after the timeout interval has elapsed.

Configuration of the timeout interval includes the recompilation of the application 107. In one example, the timeout interval can be about 1500 ms. Without intending to be bound by modeling, such an example timeout interval can result from considering typical network delays in a range from about 150 ms to about 500 ms, and typical lag time (e.g., 2600 ms) of an end-user before functionality of the application 107 begins to be utilized.

In response to receiving the content 106 before the timeout interval elapses, the computing device 112 can present a UI 116 where the content 106 is arranged according to a specific layout determined by a defined content presentation component of the content presentation components 108. The content 106 that is presented also is formatted according to the defined content presentation component. The UI 116 can be presented in a display device (not depicted in FIG. 1) integrated into the computing device 112 or functionally coupled, via a wireless or wireline connection, for example, to the computing device 112.

The computing device 112 can draw the UI 116 having individual controls corresponding to assets in the content 106, according to the defined template. To that end, the computing device 112 can execute a task within a UI thread that draws the UI 116. The data bindings for each field associated with the defined content presentation component can be filled in based at least on, for example, the content supplied by an instance of a module of the application 107. Execution of the module can cause the computing device 112 to retrieve, from the content repository 103, one or more assets mapped in the content payload included in the content 106.

In embodiments in which the defined content presentation component specifies a layout that spans a specific section of the UI 116, the computing device 112 can initially draw the UI 116 without the content 106 in the specific section. Upon receiving the content 106, or after the content 106 is received, the computing device 112 can redraw the UI 116 including the specific section intended for the content 106. Redrawing the UI 116 can include animating one or more visual elements included in the initially drawn UI 116, to accommodate the content 106. In some situations, by redrawing the UI 116 after receiving the content 106, user experience can be improved relative to other situations in which receiving the content 106 causes the computing device 112 to draw the UI 116 as a whole.

As mentioned, in some embodiment, the content management system 102 can select, in response to receiving the request 104, a specific content presentation component of the content presentation components 108 to render the UI 116. Thus, the content management system 102 can have the appropriate media assets for a group of content presentation components from which the computing device 112 can select the specific content presentation component. Accordingly, the content management system 102 can enforce constrains on media assets (such as maximum number of characters, image size and dots-per-inch (DPI), and the like) based on the specific content presentation component.

In other situations, the content 106 is supplied to the computing device 116 and read and parsed by the computing device 112 when or after the timeout interval elapses. In response, the computing device 112 can present default content in a UI, according to a defined content presentation component. In addition, the computing device 112 also can retain any received media assets within one or more memory devices 114 (referred to as a content cache 114). Thus, the computing device 112 can fulfill further requests for the content 106 without reliance on a network call to the content management system 102. In some embodiments, the content cache 114 can retain content during a defined period of time, such as one day, two days, or three days.

The technologies disclosed herein can provide, in some embodiments, caching of service-delivered content. Caching can be desired, for example, during the implementation of a directed-content campaign. In some situations, however, the directed-content campaign can be time-sensitive and/or highly specific to an end-user based on current attributes of the end-user. As such, cached directed content impressions can be inconsistent with current attributes of the end-user due to intervening changes in end-user attributes since selecting the end-user for inclusion in the campaign. In those situations, network requests for service-delivered content as described herein can be relied upon.

In embodiments in which catching is supported, the computing device 112 can probe the content cache 114, for example, to determine the availability of content intended for presentation in a UI. In instances in which the content is available, the computing device 112 can cause a display device 118 to present the content. The display device can be integrated into the client device or can be functionally coupled, via a wireless or wireline connection, for example, to the client device. In instances in which the content is unavailable, the computing device 112 can acquire the content from the content management system 102, in accordance with aspects described herein.

In contrast to conventional technologies, the content 106 that can be presented in the UI 116 is selected at runtime instead of being static, determined at the time of building the application 107. The executable application 107 does not include predetermined content, except perhaps default assets utilized to render a default UI as discussed herein. In the application 107, as mentioned, a content presentation component configures a layout for presenting information in the UI 116. The layout serves as a placeholder for content and is populated with content at runtime.

The content can be received from the content management system 102 or can be included in the content cache 114. Regardless of the source of the content, the content excludes any kind of formatting information. Therefore, for a defined content presentation component, the content rendered at the UI 116 can be readily modified after the content is modified at the content management system 102.

Accordingly, the disclosed technologies for performant retrieval and presentation of content in a UI improve over conventional technologies by simply loading program code (e.g., libraries, APIs, or the like) for the executable application 107 once and using that same program code for subsequent presentation of service-delivered content on the UI, including updated directed content or other types of programmable contents. Therefore, the efficiency of the presentation of service-delivered content in accordance with this disclosure is superior to conventional technologies because, at a minimum, there is no need to load additional libraries, APIs, or other program code to present content in the UI. A defined content presentation component of the content presentation components 108 can present the content using the same libraries, APIs, or program code as those used by the application 107 to draw the UI. The performant retrieval and presentation of content according to this disclosure can be implemented on top of any native applications that present UIs.

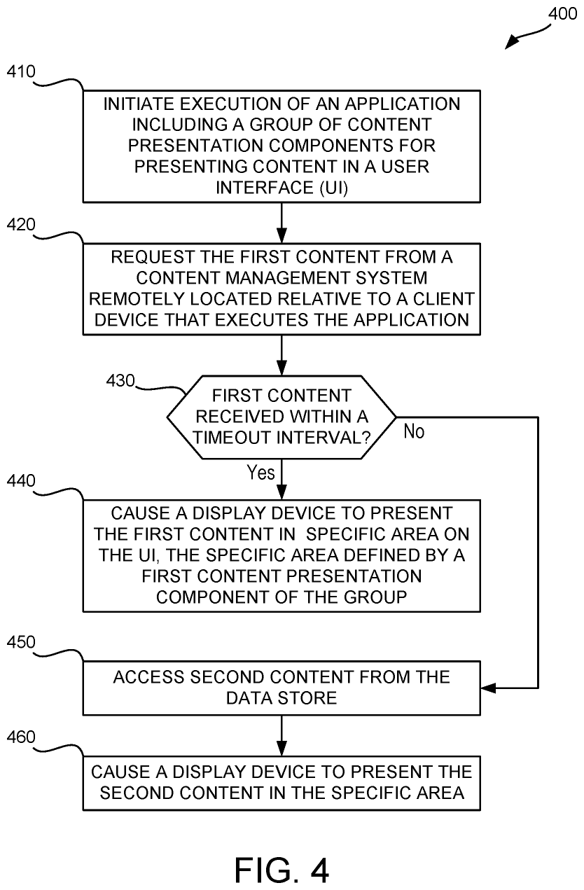

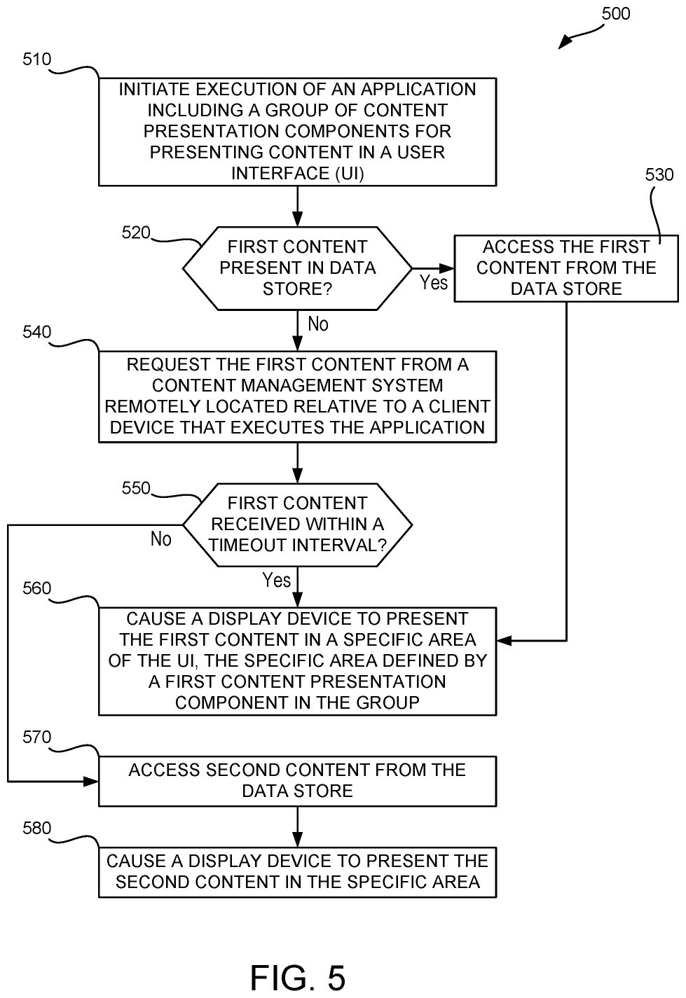

FIG. 4 and FIG. 5 are flow diagrams showing aspects of respective example methods 400 and 500, respectively, for retrieving and presenting content in a UI, according to one or more embodiments of this disclosure. As discussed above, presenting programmable content can expedite the implementation of changes to the appearance of UIs incorporated within an application, without requiring the application be rebuilt, as it would be the case with conventional technologies. It is noted that the logical operations described herein with respect to FIGS. 4 and 5, and the other techniques disclosed herein, can be implemented (1) as a sequence of computer implemented acts or program modules running on a computing device and/or (2) as interconnected machine logic circuits or circuit modules within a computing device.

The particular implementation of the technologies disclosed herein is a matter of choice dependent on the performance and other requirements of the computing device. Accordingly, the logical operations described herein are referred to variously as states, operations, structural devices, acts, or modules. These states, operations, structural devices, acts and modules can be implemented in hardware, software, firmware, in special-purpose digital logic, and any combination thereof. It should be appreciated that more or fewer operations can be performed than shown in the FIGS. and described herein. These operations can also be performed in a different order than those described herein.

The example method 400 shown in FIG. 4 begins at operation 410, where a client device can initiate execution of an application. The application includes a group of content presentation components for presenting content at predefined areas on a UI related to functionality of the application. The application can be configured to utilize multiple APIs or other types of program code to present the UI. In some instances, the application can be embodied in the application 107, FIG. 1, and such a group can include all or a subset of the content presentation components 108, FIG. 1. The client device can be embodied in, or can include, for example, the computing device 112, FIG. 1.

At operation 420, the client device can request first content from a computing system remotely located from the client device. The content can be requested at runtime, such as during the user-perceptible readiness period of the application, and essentially concurrently with the execution of the application. To that end, the client device can execute a network call essentially concurrently with the execution of the application (e.g., application 107, FIG. 1). Such a computing system can be embodied in, or can include, for example, the content management system 102. In one example, the first content can be directed to a programmable section of a defined UI of the application. Specifically, the programmable section can correspond to a programmable banner to be presented on a landing page that pertains to the application.

At operation 430, the client device can determine if the first content is received within a timeout interval (e.g., 500 ms, 1000 ms, or 1500 ms). The example method 400 continues to operation 440 in response to ascertaining that the first content is received within the timeout interval. The first content that is received excludes any kind of formatting information. At operation 440, the client device can cause a display device to present the first content in a specific area on the UI, where the specific area (area 206) is defined by a first content presentation component of the group of content presentation components. The display device can be integrated into the client device or can be functionally coupled, via a wireless or wireline connection, for example, to the client device. In addition, or in some embodiments, the example method 400 also can include an operation (not depicted in FIG. 4) at which the client device can retain the received first content in a data store.

In the alternative, in response to a negative determination at operation 430, the client device can access second content from the data store at operation 450. The second content can include default content, for example. The default content can be, in some instances, intended for presentation on the programmable section discussed herein. The second content also can exclude any kind of formatting information. The example method 400 then continues to operation 460, where the client device can cause the display device to present the second content in a specific area on the UI. The specific area (e.g., area 206) is defined by the first content presentation component.

With respect to FIG. 5, the example method 500 can be implemented in scenarios in which caching of service-delivered content is supported. The example method 500 begins at operation 510, where a client device can initiate execution of an application. The application includes a group of content presentation components for presenting content in predefined areas of a UI related to functionality of the application. The application can be configured to utilize multiple APIs or other types of program code to present the UI. In some instances, the application can be embodied in the application 107, FIG. 1, and such a group can include all or a subset of the content presentation components 108, FIG. 1. The client device can be embodied in, or can include, for example, the computing device 112, FIG. 1.

The client device can determine if first content desired or otherwise intended for presentation in the UI is cached. To that end, the client device can execute the customization component 107a or another type of software component with similar functionality. A worker thread can execute the customization component 107 essentially concurrently with a main thread that executes the application 107. Thus, the client device can determine if the first content is present in a data store (e.g., content cache 114, FIG. 1) at operation 520. The first content can be directed to a programmable section of a particular UI of the application, for example.

Specifically, the programmable section can correspond to a programmable banner to be presented in a landing page that pertains to the application. The data store can be integrated into the client device and can be embodied in, or can constitute, a memory device or another type of computer-readable storage medium of the client device. In response to a positive determination, the example method 500 continues to operation 530, where the client device can access the first content from the data store. The first content excludes any kind of formatting information. The example method 500 then continues to operation 560, where the client device can cause a display device (e.g., display device 118, FIG. 1) to present the first content in a specific area of the UI. The specific area is defined by a first content presentation component of the group of content presentation components. The display device can be integrated into the client device or can be functionally coupled, via a wireless or wireline connection, for example, to the client device.

In response to a negative determination at operation 520—e.g., the first content is not cached—the example method 500 continues to operation 540, where the client device can request the first content from a computing system remotely located from the client device. The content can be requested at runtime, such as during the user-perceptible readiness period of the application, and essentially concurrently with the execution of the application. To that end, the client device can execute a network call essentially concurrently with the execution of the application (e.g., application 107, FIG. 1). Such a computing system can be embodied in, or can include, for example, the content management system 102.

At operation 550, the client device can determine if the first content is received within a timeout interval (e.g., 500 ms, 1000 ms, or 1500 ms). The example method 500 continues to operation 560 in response to ascertaining that the first content is received within the timeout interval. In addition, or in some embodiments, the example method 500 also can include an operation (not depicted in FIG. 5) at which the client device can retain the first content that is service-delivered in the data store.

In the alternative, in response to a negative determination at operation 550, the client device can access second content from the data store at operation 570. The second content can include default content, for example. The default content can be, in some instances, intended for presentation on the programmable section discussed herein. The second content also can exclude any kind of formatting information. The example method 500 then continues to operation 580, where the client device can cause the display device to present the second content in a specific area of the UI. The specific area is defined by the first UI presentation component.

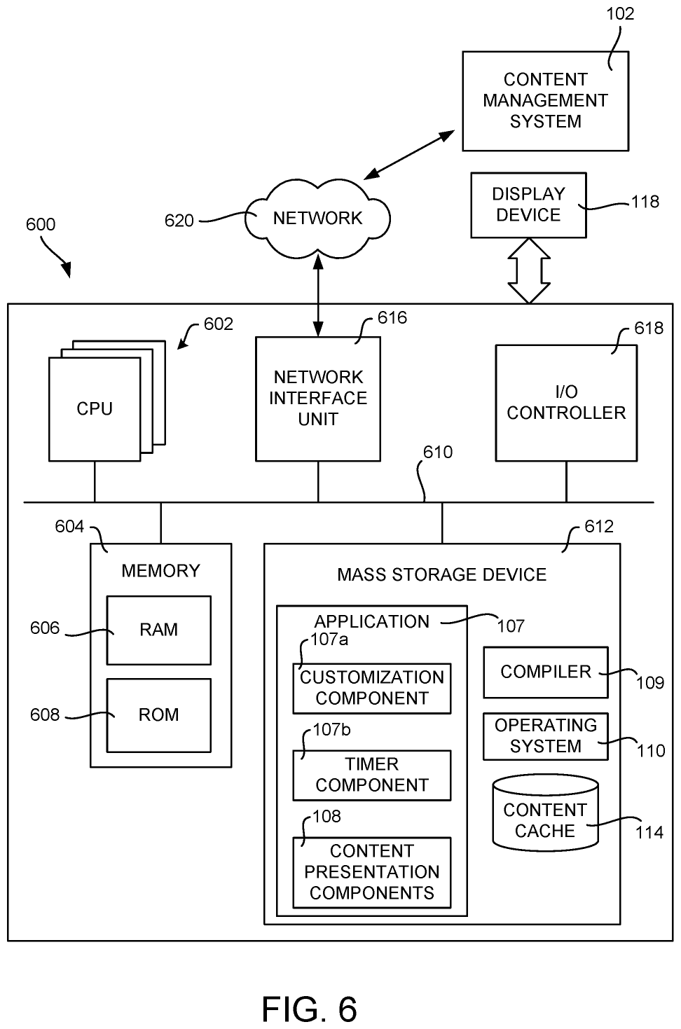

FIG. 6 is a computer architecture diagram showing an illustrative computer hardware and software architecture for a computing device that can implement the various technologies presented herein. In particular, the architecture illustrated in FIG. 6 can be utilized to implement a server computer, mobile phone, an e-reader, a smartphone, a desktop computer, an AR/VR device, a tablet computer, a laptop computer, or another type of computing device.

The computer 600 illustrated in FIG. 6 includes a central processing unit 602 (CPU), a system memory 604, including a random-access memory 606 (RAM) and a read-only memory (ROM) 608, and a system bus 610 that couples the memory 604 to the CPU 602. A basic input/output system (BIOS″ or “firmware) containing the basic routines that help to transfer information between elements within the computer 600, such as during startup, can be stored in the ROM 608. The computer 600 further includes a mass storage device 612 for storing the operating system 110, the application 107, the compiler 109, and other types of programs (not depicted). As is discussed herein and shown in FIG. 6, the application 107 includes the customization component 107a, the timer component 107b, and the multiple content presentation components 108. The mass storage device 612 also can be configured to store the content cache 114 and other types data (not depicted). Execution of the application 107, by the CPU 602, can cause the computer 600 to provide the performant retrieval and presentation of content in accordance with the technologies described herein.

The mass storage device 612 is connected to the CPU 602 through a mass storage controller (not depicted in FIG. 6) connected to the bus 610. The mass storage device 612 and its associated computer-readable media provide non-volatile storage for the computer 600. Although the description of computer-readable media contained herein refers to a mass storage device, such as a hard disk, CD-ROM drive, DVD-ROM drive, or USB storage key, it should be appreciated by those skilled in the art that computer readable media can be any available computer storage media or communication media that can be accessed by the computer 600.

Communication media includes computer readable instructions, data structures, program modules, or other data in a modulated data signal such as a carrier wave or other transport mechanism and includes any delivery media. The term “modulated data signal” means a signal that has one or more of its characteristics changed or set in a manner so as to encode information in the signal. By way of example, and not limitation, communication media includes wired media such as a wired network or direct-wired connection, and wireless media such as acoustic, radio frequency, infrared, and other wireless media. Combinations of the any of the above should also be included within the scope of computer-readable media.

By way of example, and not limitation, computer storage media can include volatile and non-volatile, removable and non-removable media implemented in any method or technology for storage of information such as computer readable instructions, data structures, program modules or other data. For example, computer storage media includes, but is not limited to, RAM, ROM, EPROM, EEPROM, flash memory or other solid-state memory technology, CD-ROM, digital versatile disks (DVD), HD-DVD, BLU-RAY, or other optical storage, magnetic cassettes, magnetic tape, magnetic disk storage or other magnetic storage devices, or any other medium that can be used to store the desired information and which can be accessed by the computer 600. For purposes of the claims, the phrase “computer storage medium,” and variations thereof, does not include waves or signals per se or communication media.

According to various configurations, the computer 600 can operate in a networked environment using logical connections to remote computers through a network such as the network 620. The computer 600 can connect to the network 620 through a network interface unit 616 connected to the bus 610. It should be appreciated that the network interface unit 616 can also be utilized to connect to other types of networks and remote computer systems. The computer 600 can also include an input/output controller 618 for receiving and processing input from a number of other devices, including a keyboard, mouse, touch input, an electronic stylus (not shown in FIG. 6), or a physical sensor such as a video camera. Similarly, the input/output controller 618 can provide output to a display screen or other type of output device (also not shown in FIG. 6).

It is noted that the software components described herein, when loaded into the CPU 602 and executed, can transform the CPU 602 and the overall computer 600 from a general-purpose computing device into a special-purpose computing device customized to facilitate the functionality presented herein. The CPU 602 can be constructed from any number of transistors or other discrete circuit elements, which can individually or collectively assume any number of states. More specifically, the CPU 602 can operate as a finite-state machine, in response to executable instructions contained within the software components disclosed herein. These computer-executable instructions can transform the CPU 602 by specifying how the CPU 602 transitions between states, thereby transforming the transistors or other discrete hardware elements constituting the CPU 602.

Encoding the software components presented herein can also transform the physical structure of the computer readable media presented herein. The specific transformation of physical structure depends on various factors, in different implementations of this description. Examples of such factors include, but are not limited to, the technology used to implement the computer readable media, whether the computer readable media is characterized as primary or secondary storage, and the like. For example, if the computer readable media is implemented as semiconductor-based memory, the software disclosed herein can be encoded on the computer readable media by transforming the physical state of the semiconductor memory. For instance, the software can transform the state of transistors, capacitors, or other discrete circuit elements constituting the semiconductor memory. The software can also transform the physical state of such components in order to store data thereupon.

As another example, the computer-readable media disclosed herein can be implemented using magnetic or optical technology. In such implementations, the software presented herein can transform the physical state of magnetic or optical media, when the software is encoded therein. These transformations can include altering the magnetic characteristics of particular locations within given magnetic media. These transformations can also include altering the physical features or characteristics of particular locations within given optical media, to change the optical characteristics of those locations. Other transformations of physical media are possible without departing from the scope and spirit of the present description, with the foregoing examples provided only to facilitate this discussion.

In light of the above, it is noted that many types of physical transformations take place in the computer 600 in order to store and execute the software components presented herein. It also should be appreciated that the architecture shown in FIG. 6 for the computer 600, or a similar architecture, can be utilized to implement other types of computing devices, including hand-held computers, video game devices, embedded computer systems, mobile devices such as smartphones, tablets, and AR/VR devices, and other types of computing devices known to those skilled in the art. It is also contemplated that the computer 600 might not include all of the components shown in FIG. 6, can include other components that are not explicitly shown in FIG. 6, or can utilize an architecture completely different than that shown in FIG. 6.

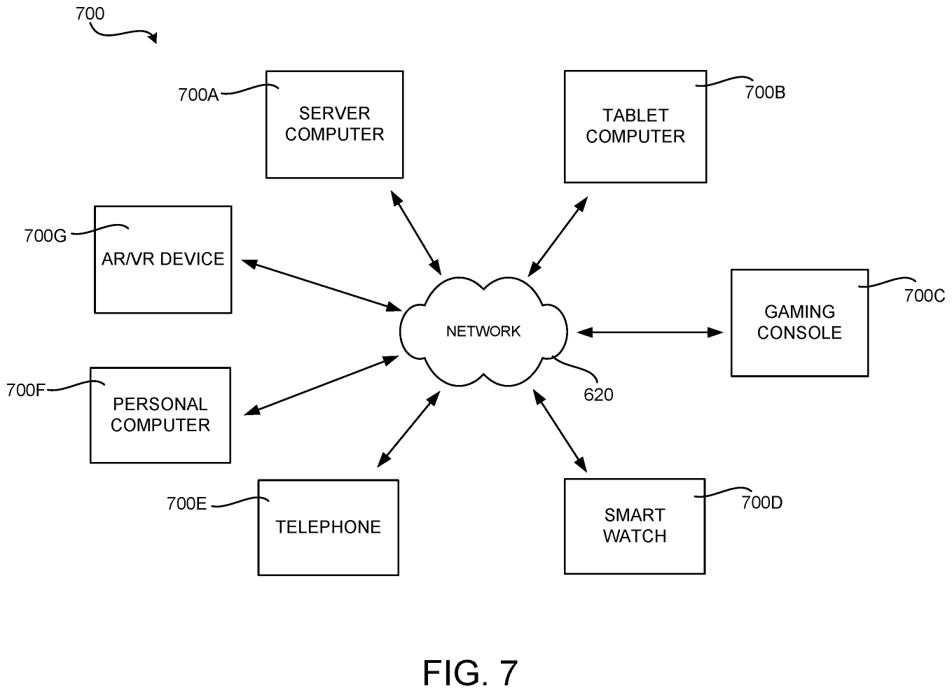

FIG. 7 is a network diagram illustrating a distributed network computing environment 700 in which aspects of the disclosed technologies can be implemented, according to various embodiments presented herein. As shown in FIG. 7, one or more server computers 700A can be interconnected via the network 620 (which may be either of, or a combination of, a fixed-wire or wireless LAN, WAN, intranet, extranet, peer-to-peer network, virtual private network, the Internet, Bluetooth™ communications network, proprietary low voltage communications network, or other communications network) with a number of client computing devices such as, but not limited to, a tablet computer 700B, a gaming console 700C, a smart watch 700D, a telephone 700E, such as a smartphone, a personal computer 700F, and an AR/VR device 700G.

In a network environment in which the network 620 is the Internet, for example, the server computer 700A can be a dedicated server computer operable to process and communicate data to and from the client computing devices 700B-700G via any of a number of known protocols, such as, hypertext transfer protocol (HTTP), file transfer protocol (FTP), or simple object access protocol (SOAP). Additionally, the networked computing environment 700 can utilize various data security protocols such as secured socket layer (SSL) or pretty good privacy (PGP). Each of the client computing devices 700B-700G can be equipped with an operating system operable to support one or more computing applications or terminal sessions such as a web browser (not shown in FIG. 7), or other graphical user interface (not shown in FIG. 7), or a mobile desktop environment (not shown in FIG. 7) to gain access to the server computer 700A.

The server computer 700A can be communicatively coupled to other computing environments (not shown in FIG. 7) and receive data regarding a participating user's interactions/resource network. In an illustrative operation, a user (not shown in FIG. 7) may interact with a computing application running on a client computing device 700B-700G to obtain desired data and/or perform other computing applications.

The data and/or computing applications may be stored on the server 700A, or servers 700A, and communicated to cooperating users through the client computing devices 700B-700G over an exemplary communications network 520. A participating user (not shown in FIG. 7) may request access to specific data and applications housed in whole or in part on the server computer 700A. These data may be communicated between the client computing devices 700B-700G and the server computer 700A for processing and storage.

The server computer 700A can host computing applications, processes and applets for the generation, authentication, encryption, and communication of data and applications, and may cooperate with other server computing environments (not shown in FIG. 7), third party service providers (not shown in FIG. 7), network attached storage (NAS) and storage area networks (SAN) to realize application/data transactions.

It is noted that the computing architecture shown in FIG. 6 and the distributed network computing environment shown in FIG. 7 have been simplified for ease of discussion. It is also noted that the computing architecture and the distributed computing network can include and utilize many more computing components, devices, software programs, networking devices, and other components not specifically described herein.

The disclosure presented herein also encompasses the subject matter set forth in the following clauses:

Clause 1: A computer-implemented method, comprising: initiating execution of an application on a computing device, the application comprising executable code for presenting content at predefined areas on a UI and being configured to utilize one or more application programming interfaces (APIs) to present the UI; requesting, concurrently with the execution of the application, first content from a content management system remotely located relative to the computing device, the first content requested during a period following execution of the application but prior to the application being able to process user input; receiving the first content from the content management system, the first content including at least one of a text string, a location of an image in a content repository, or an indication of second executable code of the application, wherein the first content excludes formatting information; and causing a display device to present the first content in the predefined areas on the UI, the first content being presented using at least a first one of the one or more APIs in response to execution of the executable code.

Clause 2: The computer-implemented method of clause 1, wherein the requesting comprises executing a network call substantially concurrently with the execution of the application.

Clause 3: The computer-implemented method of clauses 1-2, further comprising, requesting second content from the content management system; determining that a timeout interval for receiving the second content has elapsed; accessing third content from a memory device integrated into the computing device; and causing the display device to present the third content in a first area of the predefined areas.

Clause 4: The computer-implemented method of clauses 1-3, wherein the receiving comprises receiving a file containing at least a portion of the first content, the file comprising a flat JavaScript object notation (JSON) serialized key-value map.

Clause 5: The computer-implemented method of clauses 1-4, wherein the first content comprises a media asset, and wherein the method further comprises retaining the media asset in a memory device integrated into the client device.

Clause 6: The computer-implemented method of clauses 1-5, wherein the executable code defines a layout of the predefined areas, and wherein the causing the display device to present the first content comprises causing the display device to present portions of the first content in respective ones of the predefined areas.

Clause 7: The computer-implemented method of clauses 1-6, wherein the executable code further defines a first type of content corresponding to a first area of the predefined areas and a format for the first type of content, wherein the executable code further defines a second area of the predefined areas as an actionable element, and wherein the method further comprises executing a function call of the application in response to selection of the actionable element.

Clause 8: A computing device, comprising: at least one processor; at least one computer-readable non-transitory storage medium having instructions encoded thereon that, in response to execution, cause the at least one processor to: initiate execution of an application comprising executable code for presenting content at predefined areas on a user interface (UI); request, concurrently with the execution of the application, first content from a content management system remotely located relative to the computing device, the first content requested during a period prior to the application being able to process user input; receive the first content from the content management system, the first content comprising at least one of a string, a location of an image in a content repository, or an indication of second executable code of the application, the first content excluding formatting information; and cause a display device to present the first content at the predefined areas on the UI.

Clause 9: The computing device of clause 8, wherein requesting the first content comprises executing a network call for requesting the first content substantially concurrently with the execution of the application.

Clause 10: The computing device of clauses 8-9, wherein the instructions are configured to further cause the at least one processor to, request second content from the content management system; determine that a timeout interval for receiving the second content has elapsed; access third content from a cache functionally coupled to the at least one processor; and cause the display device to present the third content at the predefined areas on the UI.

Clause 11: The computing device of clauses 8-10, wherein at least a portion of the first content comprises a flat JavaScript object notation (JSON) serialized key-value map.

Clause 12: The computing device of clauses 8-11, wherein the application is configured to utilize one or more application programming interfaces (APIs) to present the UI, and wherein the first content is presented using at least a first one of the one or more APIs in response to execution of the executable code.

Clause 13: The computing device of clauses 8-12, wherein the executable code defines a layout of the predefined areas, a first area of the predefined areas corresponds to a first type of content and a second area of the predefined areas corresponds to a second type of content.

Clause 14: The computing device of clauses 8-13, wherein the executable code further defines a third area of the areas as an actionable element that causes the computing device to execute a function call in response to selection of actionable element.

Clause 15: At least one computer-readable non-transitory storage medium having instructions encoded thereon that, in response to execution, cause a computing device to perform operations comprising: initiating execution of an application on the computing device, the application comprising executable code for presenting content at predefined areas on a user interface (UI); requesting, concurrently with the execution of the application, first content from a content management system remotely located relative to the computing device, the first content requested during an initial period prior to the application being able to process user input; receiving the first content from the content management system, the first content comprising at least one of a string, a location of an image in a content repository, or an indication of second executable code of the application, the first content excluding formatting information; and causing a display device to present the first content at the predefined areas on the UI.

Clause 16: The at least one computer-readable non-transitory storage medium of clause 15, wherein the requesting comprises executing a network call substantially concurrently with the execution of the application, the network call sends a request for the content.

Clause 17: The at least one computer-readable non-transitory storage medium of clauses 15-16, wherein the operations further comprise, requesting second content from the content management system; determining that a timeout interval for receiving the second content has elapsed; accessing third content from a memory device integrated into the computing device; and causing the display device to present the third content at the predefined areas of the UI.

Clause 18: The at least one computer-readable non-transitory storage medium of clauses 15-17, wherein the receiving comprises receiving a file containing at least a portion of the first content, the file includes a flat JavaScript object notation (JSON) serialized key-value map.

Clause 19: The at least one computer-readable non-transitory storage medium of clauses 15-18, wherein the application is configured to utilize one or more application programming interfaces (APIs) to present the UI, and wherein the first content is presented using at least a first one of the one or more APIs in response to execution of the executable code.

Clause 20: The at least one computer-readable non-transitory storage medium of clauses 15-19, wherein the template defines a first type of content corresponding to a first area of the predefined areas and a format for the first type of content, and wherein the template further defines a second area of the predefined areas as an actionable element, the operations further comprising executing a function call of the application in response to selection of the actionable element.

Based on the foregoing, it should be appreciated that technologies for performant retrieval and presentation of content using a UI have been disclosed herein. Although the subject matter presented herein has been described in language specific to computer structural features, methodological and transformative acts, specific computing machinery, and computer readable media, it is to be understood that the subject matter set forth in the appended claims is not necessarily limited to the specific features, acts, or media described herein. Rather, the specific features, acts and mediums are disclosed as example forms of implementing the claimed subject matter.

The subject matter described above is provided by way of illustration only and should not be construed as limiting. Various modifications and changes can be made to the subject matter described herein without following the example configurations and applications illustrated and described, and without departing from the scope of the present disclosure, which is set forth in the following claims.

What is claimed is:

1. A computer-implemented method, comprising:
initiating execution of an application on a computing device, the application comprising executable code for presenting content at predefined areas on a UI and being configured to utilize one or more application programming interfaces (APIs) to present the UI;
requesting, concurrently with the execution of the application, first content from a content management system remotely located relative to the computing device, the first content requested during a period following execution of the application but prior to the application being able to process user input;
receiving the first content from the content management system, the first content including at least one of a text string, a location of an image in a content repository, or an indication of second executable code of the application, wherein the first content excludes formatting information; and
causing a display device to present the first content in the predefined areas on the UI, the first content being presented using at least a first one of the one or more APIs in response to execution of the executable code.

2. The computer-implemented method of claim 1, wherein the requesting comprises executing a network call substantially concurrently with the execution of the application.

3. The computer-implemented method of claim 1, further comprising, requesting second content from the content management system;
determining that a timeout interval for receiving the second content has elapsed;
accessing third content from a memory device integrated into the computing device; and
causing the display device to present the third content in a first area of the predefined areas.

4. The computer-implemented method of claim 1, wherein the receiving comprises receiving a file containing at least a portion of the first content, the file comprising a flat JavaScript object notation (JSON) serialized key-value map.

5. The computer-implemented method of claim 1, wherein the first content comprises a media asset, and wherein the method further comprises retaining the media asset in a memory device integrated into the client device.

6. The computer-implemented method of claim 1, wherein the executable code defines a layout of the predefined areas, and wherein the causing the display device to present the first content comprises causing the display device to present portions of the first content in respective ones of the predefined areas.

7. The computer-implemented method of claim 6, wherein the executable code further defines a first type of content corresponding to a first area of the predefined areas and a format for the first type of content,
wherein the executable code further defines a second area of the predefined areas as an actionable element, and
wherein the method further comprises executing a function call of the application in response to selection of the actionable element.

8. A computing device, comprising:
at least one processor;
at least one computer-readable non-transitory storage medium having instructions encoded thereon that, in response to execution, cause the at least one processor to:
initiate execution of an application comprising executable code for presenting content at predefined areas on a user interface (UI);
request, concurrently with the execution of the application, first content from a content management system remotely located relative to the computing device, the first content requested during a period prior to the application being able to process user input;
receive the first content from the content management system, the first content comprising at least one of a string, a location of an image in a content repository, or an indication of second executable code of the application, the first content excluding formatting information; and
cause a display device to present the first content at the predefined areas on the UI.

9. The computing device of claim 8, wherein requesting the first content comprises executing a network call for requesting the first content substantially concurrently with the execution of the application.

10. The computing device of claim 8, wherein the instructions are configured to further cause the at least one processor to,
request second content from the content management system;
determine that a timeout interval for receiving the second content has elapsed;
access third content from a cache functionally coupled to the at least one processor; and
cause the display device to present the third content at the predefined areas on the UI.

11. The computing device of claim 8, wherein at least a portion of the first content comprises a flat JavaScript object notation (JSON) serialized key-value map.

12. The computing device of claim 8, wherein the application is configured to utilize one or more application programming interfaces (APIs) to present the UI, and wherein the first content is presented using at least a first one of the one or more APIs in response to execution of the executable code.

13. The computing device of claim 8, wherein the executable code defines a layout of the predefined areas, a first area of the predefined areas corresponds to a first type of content and a second area of the predefined areas corresponds to a second type of content.

14. The computing device of claim 13, wherein the executable code further defines a third area of the areas as an actionable element that causes the computing device to execute a function call in response to selection of actionable element.

15. At least one computer-readable non-transitory storage medium having instructions encoded thereon that, in response to execution, cause a computing device to perform operations comprising:
initiating execution of an application on the computing device, the application comprising executable code for presenting content at predefined areas on a user interface (UI);
requesting, concurrently with the execution of the application, first content from a content management system remotely located relative to the computing device, the first content requested during an initial period prior to the application being able to process user input;
receiving the first content from the content management system, the first content comprising at least one of a string, a location of an image in a content repository, or an indication of second executable code of the application, the first content excluding formatting information; and
causing a display device to present the first content at the predefined areas on the UI.

16. The at least one computer-readable non-transitory storage medium of claim 15, wherein the requesting comprises executing a network call substantially concurrently with the execution of the application, the network call sends a request for the content.

17. The at least one computer-readable non-transitory storage medium of claim 15, wherein the operations further comprise,
requesting second content from the content management system;
determining that a timeout interval for receiving the second content has elapsed;
accessing third content from a memory device integrated into the computing device; and
causing the display device to present the third content at the predefined areas of the UI.

18. The at least one computer-readable non-transitory storage medium of claim 15, wherein the receiving comprises receiving a file containing at least a portion of the first content, the file includes a flat JavaScript object notation (JSON) serialized key-value map.

19. The at least one computer-readable non-transitory storage medium of claim 15, wherein the application is configured to utilize one or more application programming interfaces (APIs) to present the UI, and wherein the first content is presented using at least a first one of the one or more APIs in response to execution of the executable code.

20. The at least one computer-readable non-transitory storage medium of claim 15, wherein the template defines a first type of content corresponding to a first area of the predefined areas and a format for the first type of content, and
wherein the template further defines a second area of the predefined areas as an actionable element,
the operations further comprising executing a function call of the application in response to selection of the actionable element.
